(19) United States
(12) Patent Application Publication
(10) Pub. No.: US 2006/0199051 A1
(43) Pub. Date: Sep. 7, 2006

(54) Combined heat and power system

(76) Inventors: Dingrong Bai, Dorval (CA); Jean-Guy Chouinard, Ville St-Laurent (CA); David Elkaim, Ville St-Laurent (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/072,646

(22) Filed: Mar. 7, 2005

(51) Int. Cl. H01M 8/04; H01M 8/06

(52) U.S. Cl. 429/17; 429/26; 429/20; 429/22; 429/24

(57) ABSTRACT

There is described a combined heat and power, or cogeneration, system combining a fuel cell for generating electrical power with a thermal power source, the system comprising: a fuel processor for converting a hydrocarbon fuel into hydrogen in an output stream, the hydrogen rich output stream containing a low content of carbon monoxide; a high temperature hydrogen fuel cell system tolerant to low content of carbon monoxide of up to 5% receiving the output stream and an oxidant fluid stream; and a heat exchange system having a first module associated with the fuel processor and a second module associated with the fuel cell system connected at least in part in series to provide a thermal output.

### CROSS-REFERENCE TO RELATED APPLICATIONS

This is the first application filed for the present invention.

### TECHNICAL FIELD

The invention generally relates to a combined heat and power (CHP) fuel cell system. Particularly, this invention relates to an integration of a high temperature proton exchange membrane fuel cell and a steam reforming based fuel processor to produce electricity and domestic hot water from hydrocarbon fuels.

### BACKGROUND OF THE INVENTION

Residences and other commercial and industrial buildings such as hospitals, restaurants and schools require basic electricity for lights and electric appliances and thermal energy for space and domestic hot water heating. Fuel cell combined heat and power (CHP), or cogeneration, system can provide both useful electricity and thermal energy to meet these needs more effectively than conventional systems because, unlike the conventional centralized power plant, thermal energy rejected during the on-site production of electricity can be effectively recovered to meet thermal loads.

Fuel cell based CHP systems are particularly attractive because of their high efficiencies, clean, small size, excellent part load performance as well as flexibility and security.

Proton exchange membrane fuel cells (PEMFCs) have been under some development for residential and small stationary applications. A typical conventional PEM fuel cell contains a proton conducting ion exchange membrane as the electrolyte material that is sandwiched between platinum loaded electrodes. The membrane material is generally a fluorinated sulfonic acid polymer commonly referred by the trade name given to a material developed and marketed by DuPont—Nafion®, or XUS 13204.10 by Dow Chemical Company. Fuel cells using perfluorosulfonic acid polymer membranes as electrolyte, operating normally between 60 and 85° C., have been demonstrated to have excellent start-up and load following capabilities. However, these fuel cells still need further improvements in terms of reliability, lifetime and cost in order to obtain widespread commercial acceptance.

First, the performance and lifetime of a PEMFC are strongly dependent on the water content of the polymer electrolyte, so water-management in the membrane is critical for efficient operation. The conductivity of the perfluorosulfonic acid polymer membrane is a function of the number of water molecules available per acid site. If the membrane dries out, its resistance to the flow of protons increases, the electrochemical reaction occurring in the fuel cell can no longer be supported at a sufficient state, and consequently the output current decreases or, in the worst case, stops. In addition, the membrane dry-out can lead to structural cracking of the PEM surface, which consequently shortens its lifetime. For these reasons, PEM fuel cells commonly incorporate an element to humidify the incoming reactant streams, and the fuel cell operation temperature is limited below 100° C., typically between 60 and 85° C., at atmospheric pressure, beyond which the conductivity of the membrane reduces dramatically since water is lost due to vaporization. The humidifiers should be operated to have the reactant streams fully saturated at the temperatures slightly lower than, or close to, the fuel cell operation temperature. This certainly needs careful design and operation of the humidifier, which leads not only to complexity in operation but also to increases in cost and decreases in reliability.

On the other hand, if there is too much water, caused by whatever reasons such as more water brought in by the reactant streams or the accumulated water that is generated by the electrochemical reaction but not effectively removed from the fuel cell, the fuel cell electrodes can become flooded which also degrades the cell performance. Moreover, the nature of low temperature operation may result in a situation that the by-product water does not evaporate faster than it is produced. Consequently, this could lead to water accumulation and eventually electrode flooding if the water could not be removed effectively. For this reason, water removal and management has to be addressed properly in fuel cell designs.

Difficulties in water management in PEM fuel cell operation attributes are primarily due to the low-temperature limitation of perfluorosulfonic acid polymer membranes, i.e. its sensitivity to water content and narrow range of operating conditions.

Second, low temperature operation of PEM fuel cells also creates a strict requirement for CO containment in fuel stream. It has been proven that low-temperature PEM fuel cell performance drops with a CO concentration of only several parts per million (ppm). The performance degradation due to CO poisoning is believed to be due to the strong chemisorption force of CO onto the Pt catalyst active sites, which reduces the active catalyst sites available for hydrogen and thus inhibits the hydrogen from reacting.

There are presently several techniques to counter the problem of CO poisoning. First, a preferential oxidation reactor (PROX) must be installed in a fuel processor to reduce CO levels to preferably below 10 ppm. This CO level is achievable with most current PROX catalysts and designs under steady state operations, but it is difficult to maintain under transient conditions such as start-up and during sudden load changes, under which transient spikes of CO as high as a few hundreds to a few thousands ppm may be superimposed on steady state trace amounts of CO in the hydrogen-rich reformate. M. Murthy et al. (The Effect of Temperature and Pressure on the Performance of a PEMFC Exposed to Transient CO Concentrations, Journal of The Electrochemical Society, vol. 150, No. 1, pp. A29-A34, 2003) has experimentally determined the cell voltage declination rate as 0.46 V/min with 500 ppm CO and 1.43 V/min with 3000 ppm CO. With a typical cell voltage of 0.7 V the above observations suggest that the fuel cell will no longer operable within less than 1 minute if it is exposed to a reformate containing 500 ppm CO. Even exposing to 50 ppm CO, the fuel cell will lose about 30% in efficiency in just about one week operation.

Another disadvantage of using PROX reactor is reformate dilution and hydrogen consumption due to introduction of air into the PROX reactor. Although the PROX catalysts generally have high selectivity to CO oxidation, oxidation of hydrogen in reformate is unavoidable because they compete under operation conditions. Nitrogen brought in by air would result in dilution of hydrogen reformate, which would eventually lower the fuel cell performance.

To minimize the effect of CO damage to fuel cells, both accumulative and transient, a second approach, i.e. air-bleeding, is sometimes used, in which a carefully controlled air is introduced to mix with reformate in fuel cells. The air bleeding can be periodically or constantly. With air bleeding the CO poisoning can be minimized, but this increases the system complexity and cost.

It has been well documented that the tolerance of fuel cell to CO increases significantly at elevated temperatures. For Pt-based catalysts, an operation temperature of above 150° C. is typically required in order for the fuel cell to be sustainable up to 1 to 3% of CO, under such temperatures CO adsorption is much less pronounced.

Operating a PEM fuel cell at elevated temperatures will not only increase its CO tolerance, but also brings several other benefits. First and most important benefit relies on improvement of fuel cell reliability by being able to simplify water management, to eliminate reactant humidification, and to simplify fuel processor design and operation in which the aforementioned PROX reactor can be eliminated. In addition, high temperature will enhance fuel cell reaction kinetics, especially for cathode oxygen reduction rate, and increase the ionic conductivity, and consequently the cell performance will be improved at high temperatures. Furthermore, it becomes more efficient and economic at high temperatures with respect to fuel cell system thermal management, because high fuel cell temperatures provide higher heat transfer driving force, and therefore the heat exchanger size and cost can be substantially reduced compared to at low temperatures. Instead of producing hot water, high temperature fuel cell system will also allow production of low to moderate pressure steam for space heating or vapor heat pumps.

High temperature PEM fuel cells, in addition to their claimed advantages for automotive applications, are also attractive for stationary and residential combined heat and power applications.

High temperature operations of PEM fuel cells become possible when the conventional low temperature Nafion® based membrane is replaced with so-called high temperature membrane. The newest technology in the field is based on polybenzimidazoles (PBI) membrane, which has been described in US Pat. Nos. 5,091,087, 4,814,399, 5,599,639, 5,525,436, US patent application Nos. 2004/0028976, and JP 2002-198067, WO 01/18894 with respect to preparation, treatment and manufacturing. PBI based membrane becomes a proton conductor with appropriate treatment that exhibits high electrical conductivity (Journal of Electrochemical Society Vol. 142 (1995), L21-L23), excellent thermal stability (Journal of Electrochemical Society, Vol. 143 (1996), 1225-1232), nearly zero water drag coefficient (Journal of Electrochemical Society, Vol. 143 (1996), 1260-1263), and enhanced activity for oxygen reduction (Journal of Electrochemical Society, Vol. 144 (1997), 2973-2982). Recently, PBI high temperature polymer electrode membrane assembly has become commercially available (Celtec® MEA) from PEMEAS (formerly Celanese Ventures GmbH, Germany).

PEM fuel cell CHP or cogeneration systems known from the prior art mostly operate at temperatures between 60 and 85° C., in which a low temperature PEM stack is integrated with either a steam reforming (SR) based or autothermal reforming (ATR) based fuel processor. US patent application No. 2002/0160239 issued to Richard H. Cutright et al. disclosed a high temperature fuel cell system, which has an operation temperature of 120-200° C. In one of the preferred embodiments an ATR based fuel processor is used to produce a hydrogen containing reformate, and a PBI based fuel cell stack to produce electricity. The fuel cell cathode exhaust (or cathode off gas) is used to provide steam and oxygen to the ATR fuel processor. The process as disclosed has several shortcomings, including: (1) it is difficult or impossible to provide ATR fuel processor with both steam/carbon ratio and oxygen/fuel ratio at their appropriate values, which are critical parameters for ATR fuel processor to achieve its optimal operation performance, by such flow arrangement; (2) it is problematic during start-up because the required steam for fuel processing will not be available during start-up when fuel cell has not been yet in operation.

The aforementioned patent claimed that steam reformer could be used to convert hydrocarbon fuels to hydrogen. But it did not teach how the steam reforming process is configured, nor did the patent disclose a combined heat and power system based on steam reformer and high temperature PEM fuel cells. Furthermore, there are no teachings about a cogeneration system in which fluid and thermal managements and configuration, as well as operation of such a cogeneration system are provided.

### SUMMARY OF THE INVENTION

The invention relates to a combined heat and power (CHP), or cogeneration system based on hydrocarbon steam reforming for hydrogen production and high temperature PEM fuel cell for power generation.

According to a first broad aspect of the present invention, there is provided a method of initiating operation of a fuel cell system having a fuel processor for generating hydrogen from a hydrocarbon fuel, and a high temperature hydrogen/air fuel cell, the method comprising: preheating the fuel processor to perform without risk of catalyst damage and deactivation due to reasons including water condensation and CO poisoning using electric heaters and a gas burner; operating the fuel processor to begin hydrogen generation while feeding hydrogen back into the gas burner as required; preheating a fuel cell stack of the fuel cell to a first preferred temperature by electric heaters, above which water in refortnate will not be condensed over high temperature membrane electrode assemblies (MEA) of the fuel cell stack to cause acid washout; feeding hydrogen gas from the fuel processor at a second preferred temperature to preheat the fuel cell stack while drawing no substantial current from the fuel cell stack by operating the fuel processor under self-sustainable conditions, the second temperature being a temperature above which current can be safely drawn without damaging the high temperature MEA; preheating the fuel cell stack to its operation temperature by stack self-preheating; and subjecting the fuel cell to normal operation after reaching the operation temperature.

By monitoring the profiles of both electric power and thermal energy loads, the CHP system will be preferably operated at a simple stepwise load-following mode with preferably 2 to 3 cycles a day. The switches between different cycles are determined so that CHP system would provide essentially all thermal demand with lesser purchase of grid electricity, allowing CHP system to be operated more efficiently.

According to a second broad aspect of the present invention, there is provided a combined heat and power, or cogeneration, system combining a fuel cell for generating electrical power with a thermal power source, the system comprising: a fuel processor for converting a hydrocarbon fuel into hydrogen in an output stream, the hydrogen rich output stream containing a low content of carbon monoxide; a high temperature hydrogen fuel cell system tolerant to carbon monoxide of up to 5% receiving the output stream and an oxidant fluid stream; and a heat exchange system having a first module associated with the fuel processor and a second module associated with the fuel cell system connected at least in part in series to provide a thermal output.

In preferred embodiments of the present invention the CHP modules generally are functional grouped and mechanically manufactured modules. It is more preferable that the fuel processor components are arranged in such a manner so that they have a preferred temperature gradient to allow the high temperature fuel cell stack to be mechanically located right besides the fuel processor to provide a combined fuel processor and fuel cell module in a compact package. The fluid communications between various components can be accomplished by either external piping connections or internal manifolds. Thermal insulation materials can be used between different components having different operation temperatures.

The fuel processor used in this invention is preferably steam reforming based, in which a steam reformer with suitable catalyst, typically Ni based, converts a hydrocarbon fuel such as natural gas into a gas stream containing hydrogen, carbon monoxide and carbon dioxide as well as residual hydrocarbon and steam. The steam reforming is a chemical process well documented in the art and has been characterized by its high efficiency in hydrogen production compared to other fuel processing process such as autothermal reforming. The steam reformer is operated with a steam to carbon ratio of 2 to 4, and preferably between 2.5 to 3 and at temperatures of 650-700° C. The fuel processor also includes a medium temperature water-gas shift reactor with an operation temperature of preferably 160-200° C., the same temperature under which the high temperature fuel cell operates. The fuel processor can further include a steam generator to generate steam to be used in steam reforming. There may also have various heat exchangers inside the fuel processor to bring the various streams to their appropriate temperatures in each step of the process. The fuel processor, in comparison to that commonly used with a low-temperature fuel cell CHP system, has eliminated the PROX reactor, and associated reformate cooler and condenser. The carbon monoxide will be at levels of about 0.2-0.6% in the hydrogen rich reformate before being introduced into the high temperature fuel cells. The elimination of PROX, due to increased tolerance of CO by high temperature fuel cells will significantly increase the simplicity and reliability of fuel processor. It also results in an increase in fuel processor efficiency, which eventually contributes to CHP system efficiency, due to elimination of nitrogen dilution of reformate and hydrogen consumption that would have occurred in PROX reactor.

The high temperature PEM fuel cell in this invention can be based on PBI membrane available from, for example, PEMEAS (formerly Celanese Ventures GmbH). The fuel cell can be operated at a temperature between 120 and 200° C., and more preferably between 160 and 200° C. Compared to low temperature PEM fuel cells, high temperature membrane fuel cells can be tolerant of CO up to 3% without noticeable performance degradation. Furthermore, there is no necessity to humidify the reactant gases, enabling elimination of the troublesome humidification process and greatly simplify the water management, a significant technical difficulty for low temperature PEM fuel cells. Consequently, the high temperature fuel cells will be expected to be more reliable, robust and efficient.

The heat recovery module typically includes a water tank for storage of recovered thermal energy, and a water pump for circulating the cogeneration fluid. The hot water after fuel cell cogeneration heat exchanger will have a temperature between 60 and 65° C., and water from the storage tank is preferably drawn from the tank bottom where the water has a temperature between 10 and 45° C. There may be a supplementary gas water heater either inside or outside the heat recovery module for use when there is not enough thermal energy from the CHP system to meet the house demand.

Various embodiments of the invention can include the following features, alone or in combination. A hydrocarbon feed stream is preheated by a hot stream such as reformate by arranging a heat exchanger to a temperature of about 200-250° C. suitable for a downstream hydrodesulfurizer. Both organic and inorganic sulfur compounds should be removed at least below 1 ppm in order to prevent the steam reforming catalyst and shift reactor catalyst from poisoning and deactivation. The hydrogen required for hydrodesulfurization can be recycled from the outlet of shift reactor through any preferred mechanism. A de-ionized water is pumped through a heat exchanger to be preheated by a hot stream such as reformate before flowing into a steam boiler or vaporizer. The superheated steam mixes with desulfurized hydrocarbon feed before entering the steam reformer. A burner capable of burning mixture of hydrocarbon and hydrogen containing fuel cell anode exhaust gas will supply necessary thermal energy for steam reformer. The air required for combustion can be supplied by a separate air blower, or by the fuel cell cathode exhaust air that is supplied by a cathode air blower or compressor. The cathode air is preheated to a temperature close to stack temperature by either hot cathode exhaust gas, or by stack coolant. The fuel cell stack is cooled by running a coolant through its coolant channels. The heat generated by the fuel cell stack is transferred to the cogeneration fluid by a heat exchanger. The heat exchanger used for preheating cathode air can be a separate one, or combined with fuel cell plates. The thermal energy from the burner exhaust and fuel cell cathode exhaust can also be recovered by arranging heat exchanges with cogeneration fluid.

A CHP system according to the present invention will have great robustness and high reliability, and be able to achieve a total efficiency (electric and thermal) of as high as 97% (LHV, or lower heating value) when natural gas is used as fuel.

### BRIEF DESCRIPTION OF THE DRAWINGS

Further features and advantages of the present invention will become apparent from the following detailed description, taken in combination with the appended drawings, in which:

FIG. 1 is a general schematic of a steam reforming and high temperature fuel cell based combined heat and power system according to one embodiment of the invention;

FIG. 2a is a flow diagram of an integrated balance of plant module of FIG. 1 according to one embodiment of the invention;

FIG. 2b is another flow diagram of an integrated balance of plant module of FIG. 1 according to a second embodiment of the invention;

FIG. 3a is a flow diagram of an integrated fuel processor module of FIG. 1 according to one embodiment of the invention;

FIG. 3b is another flow diagram of an integrated fuel processor module of FIG. 1 according to a second embodiment of the invention;

FIG. 4a is a flow diagram of an integrated fuel cell module according to one embodiment of the invention;

FIG. 4b is another flow diagram of an integrated fuel cell module of FIG. 1 according to a second embodiment of the invention;

FIG. 5a is a flow diagram of a heat recovery module of FIG. 1 according to one embodiment of the invention;

FIG. 5b is another diagram of a heat recovery module of FIG. 1 according to a second embodiment of the invention;

FIG. 5c is another diagram of a heat recovery module of FIG. 1 according to a third embodiment of the invention;

FIG. 6a is a schematic illustrating a high temperature fuel cell anode plate that integrates an active area and a cathode air heating area according to one embodiment of the invention;

FIG. 6b is a schematic illustrating a high temperature fuel cell cathode plate that integrates an active area and a cathode air heating area according to one embodiment of the invention;

FIG. 6c is a schematic illustrating a high temperature fuel cell coolant plate according to one embodiment of the invention;

FIG. 7a is a schematic illustrating a high temperature fuel cell cathode plate that integrates an active area and a cathode air heating area according to a second embodiment of the invention;

FIG. 7b is a schematic illustrating the back side surface of a high temperature cathode plate of FIG. 7a according to a second embodiment of the invention;

FIG. 7c shows a schematic structure of area A and area B in FIGS. 7a and 7b

FIG. 8 illustrates the mean temperature profile of a combined fuel processor and fuel cell package;

FIG. 9 illustrates a typical electric load profile and corresponding load-following operation of CHP system according to the invention;

FIG. 10 shows typical profiles of thermal energy demand and thermal energy produced by CHP system in accordance with the present invention;

FIG. 11 shows accumulative amounts of thermal energy production, consumption and losses in accordance with the present invention;

FIG. 12 shows a schematic of power conditioning module;

It will be noted that throughout the appended drawings, like features are identified by like reference numerals.

### DETAILED DESCRIPTION OF THE PREFERRED EMBODIMENT

Throughout the description, the term “membrane electrode assembly” (MEA) will be understood as consisting of a solid polymer electrolyte or ion exchange membrane disposed between two electrodes formed of porous, electrically conductive sheet material, typically carbon paper or carbon cloth but not limited thereto. The MEA contains a layer of catalyst, typically in the form of platinum, at each membrane/electrode interface to induce the desired electrochemical reaction. The term “low temperature PEM” or “low temperature MEA” refers to proton exchange membrane or membrane electrode assembly materials that are suitable for operation in temperatures of about 60 to 85° C., and such materials include those commercially available from 3M, W. L. Gore and Associates, DuPont and others. The term “high temperature PEM” or “High temperature MEA” refers to proton exchange membrane or membrane electrode assembly materials that are suitable for operation in temperatures of about 120 to 200° C., and such materials include those commercially available from PEMEAS.

Furthermore, the term “steam reforming” or “steam reformer” refers to a process or device that produces hydrogen rich synthesis gas from such hydrocarbon fuels as natural gas (NG) and liquefied petroleum gas (LPG) by reacting the hydrocarbon fuel with steam over a suitable catalyst. The term “fuel processor” includes steps involved in hydrogen production such as steam reforming, water gas shift (or simply called shift), desulfurization, and heat exchanges. To distinguish the hydrocarbons supplied to steam reformer and to burner, the former is termed as “feed” and the latter as “fuel”. The gas stream unreacted in the anode of fuel cells is alternatively termed as “anode off gas” or “anode exhaust”. The gas stream unreacted in the cathode of fuel cells is alternatively termed as “cathode off gas” or “cathode exhaust”.

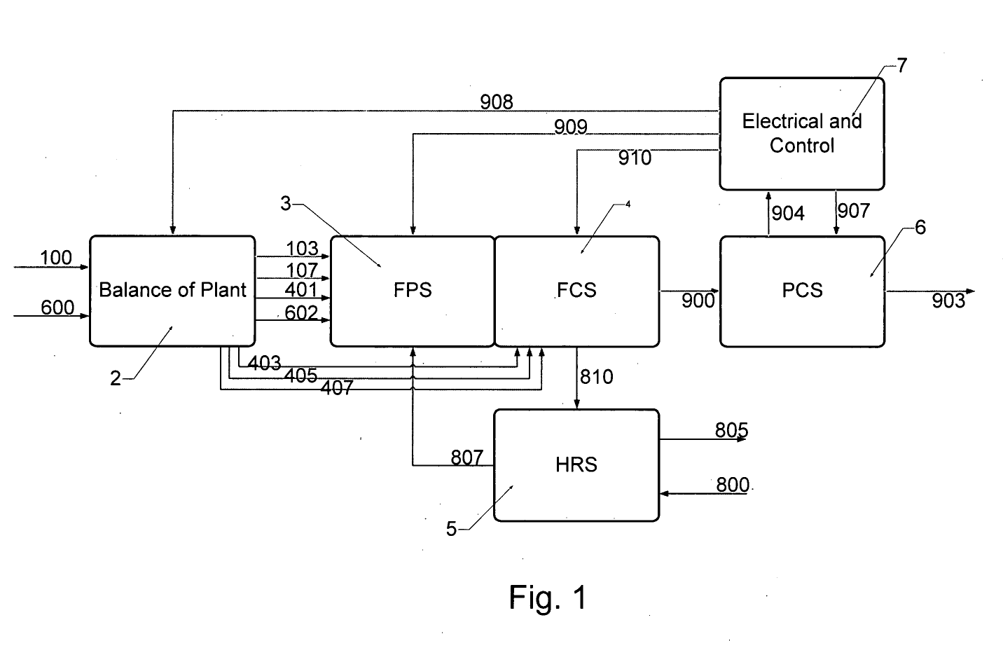

In accordance with the principles of the present invention, a steam reforming and high temperature fuel cell based CHP system is provided with an appropriate modular arrangement capable of producing both useful electric power and thermal energy from hydrocarbon fuels such as natural gas. The CHP system 1 of the present invention, as generally depicted in FIG. 1, has at least six modules or modules, all of them can be mechanically designed and manufactured independently and can be easily integrated to provide a compact functional system or product. There is provided a first module 2, Balance of Plant (BOP) module, in which all the system axillaries such as solenoid valves, meters, hydrocarbon and air filters, pressure regulators, pumps and air blowers or compressors, and other necessary fittings or connectors are collectively installed. This balance of plant module is preferably built on a panel on which axillaries can be mounted solidly and can be installed on and removed from the CHP system enclosure. The connection between the components or devices on the balance of plant panel can be either rigid or flexible tubing, with or without insulation whichever is necessary. The hydrocarbon fuel 100 and water 600 are connected to the inlet ports of the balance of plant module 2 from their individual supplying sources. All electronically driven axillaries on 2 are powered and controlled by connecting a cable 908 which transmits a regulated DC power preferably at 12 V or 24 V, an electrical control signal and an electrical feedback signal, between the balance of plant module 2 and an electrical and control module 7. The streams of hydrocarbon fuel 103, 107, air 401, and deionized water 602, are sent from output ports of the balance of plant module 2 to fuel processor module 3, and air streams 403, 405 and 407 are sent to fuel cell module 4. Within the fuel processor module (FPS) 3, appropriate fluid and thermal managements are arranged so that the hydrocarbon fuel can be efficiently converted into hydrogen rich synthesis gas, or often called reformate, containing less than 1-3% of CO. The components inside the fuel processor module are also arranged in an appropriate manner so that a fuel cell module (FCS) 4 can be mechanically installed just beside the fuel processor 3. In other embodiment of the present invention, the fuel processor module 3 and fuel cell module 4 can be designed and manufactured as an integrated compact module. Cables transmitting electrical power and control signals 909 and 910 may be connected between fuel processor module 3, fuel cell module 4 and electrical and control module 7 for powering and controlling some electronic elements such as electric heaters therein. The fuel processor module 3 and fuel cell module 4 are also connected to a cogeneration loop, 807 and 810, to have the thermal energy recovered from such sources as combustion flue gas, fuel cell stack, and fuel cell cathode exhaust. The recovered thermal energy will be recovered by a heat recovery module (HRS) 5, which receives city water 800 and supplies hot water 805. The recovered thermal energy can be used for providing domestic hot water and thermal space heating (e.g. floor heating). It can also be used as thermal driving force of an absorption heat pump as an air-conditioner. A part of the unregulated DC power 900 produced by fuel cell module 4 is converted to a regulated DC power 904, and a regulated AC power 903 in a power conditioning module (PCS) 6. There is also provided an interface on PCS 6 to receive an AC power 907 from an existing grid, which would be converted into a regulated DC power within PCS 6 to replace DC power 904 during CHP system startup.

One would appreciate that a CHP system, having been constructed based on the above described modular concepts, will have improved system reliability, manufacturability, and serviceability due to its simplicity and compactness. Consequently, the cost associated with manufacturing, assembly, and service can be reduced.

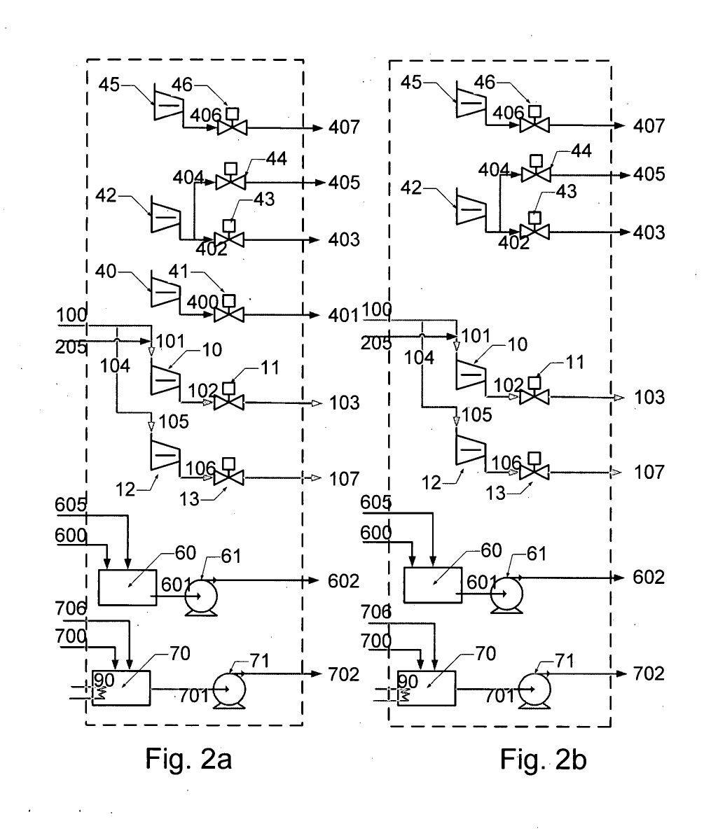

Now referring to FIGS. 2 to 11 for some of the preferred embodiments according to the present invention. For simplicity, only modules 2, 3, 4, 5 and 6 of FIG. 1 are illustrated.

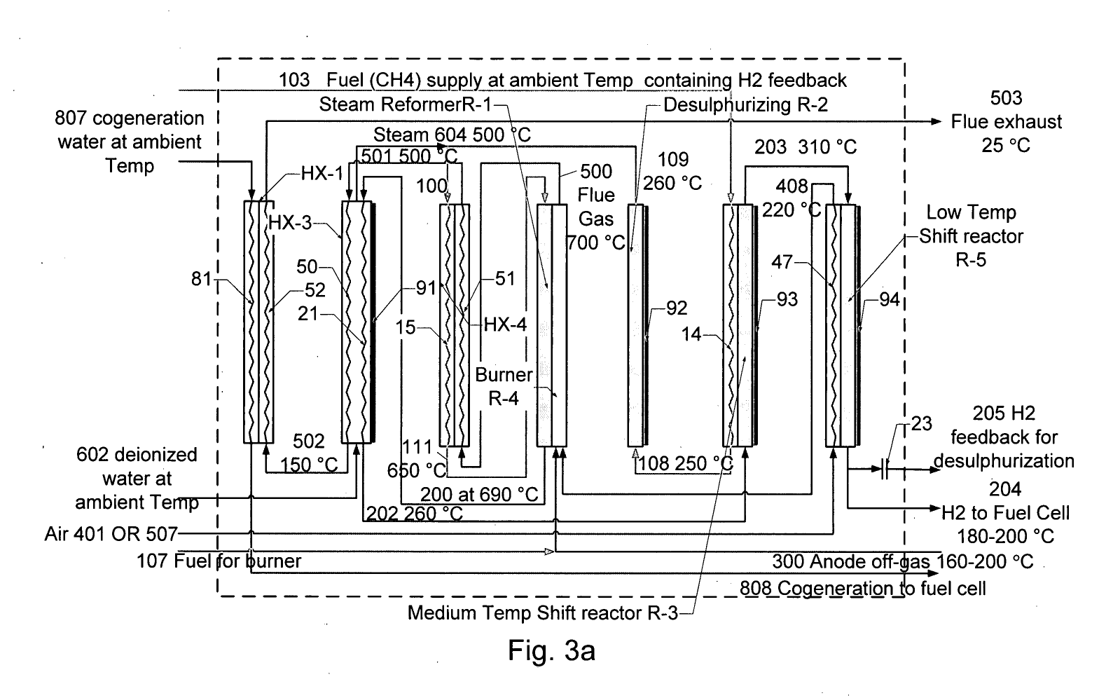

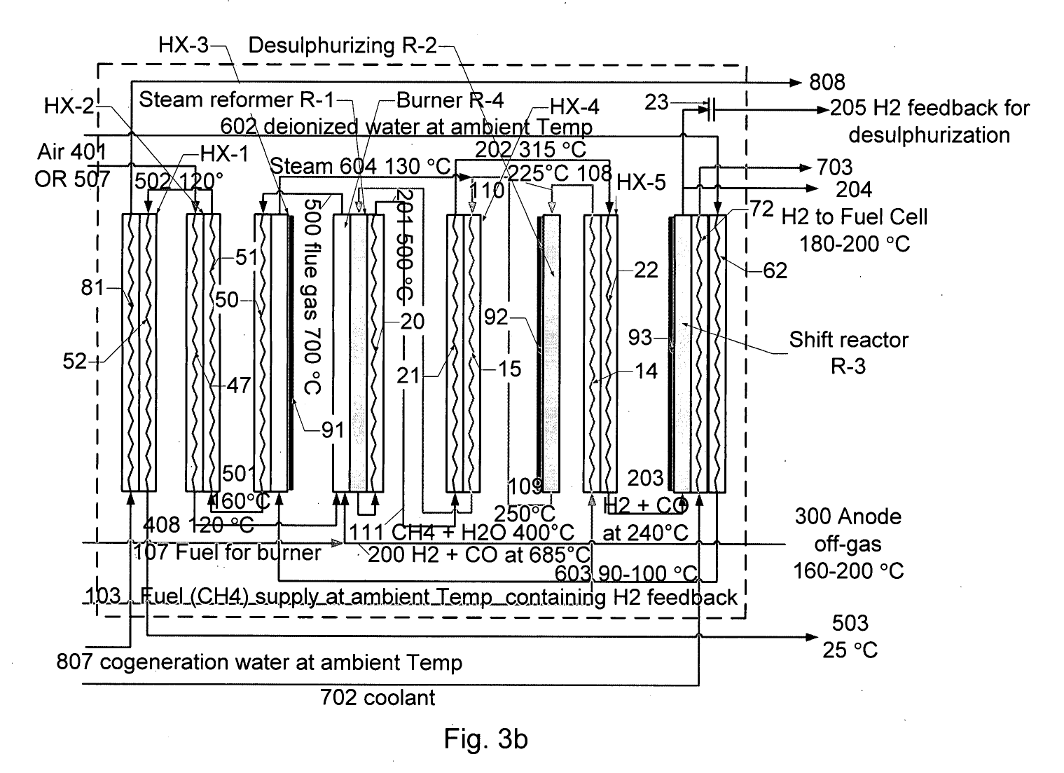

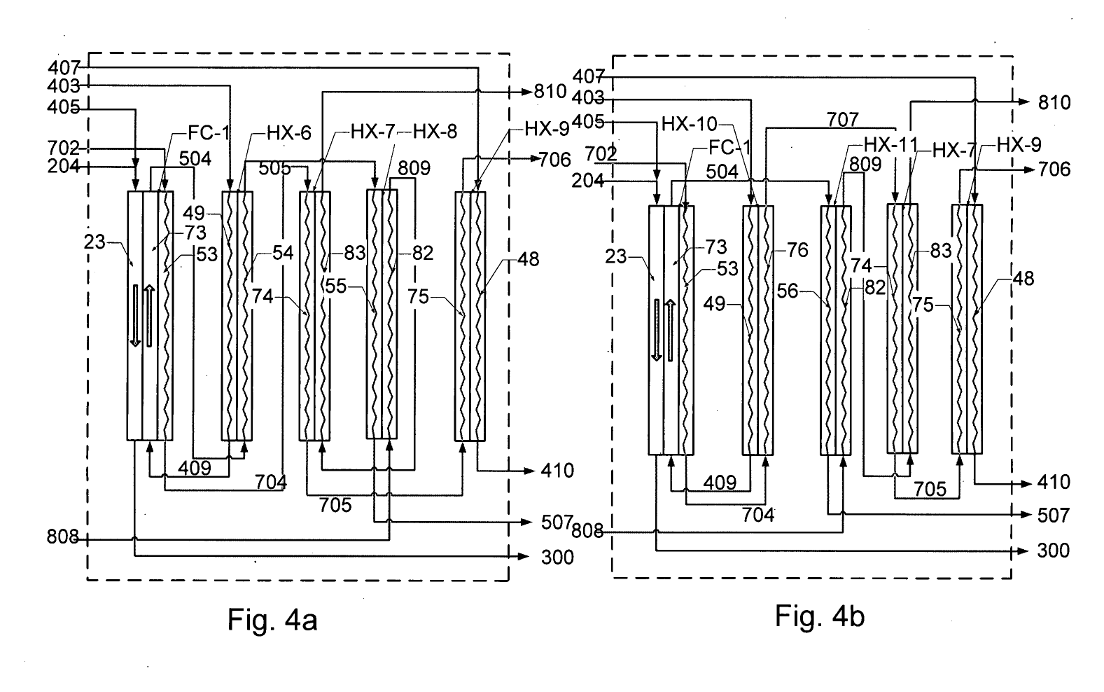

In one of the preferred embodiments as shown in FIG. 2, the balance of plant module 2a collectively installs an air blower/compressor 42 for supplying air 403 to the fuel cell cathode, an air blower/compressor 40 for supplying combustion air 401 to the burner inside the fuel processor, an air blower/compressor 45 for supplying cooling air 407 to a heat exchanger inside the fuel cell module 4, two compressors 10 and 12 for supplying hydrocarbon feed 103 and fuel 107 to steam reformer and burner, respectively. Two pumps 61 and 71 supply a deionized water 602 and a coolant 702 to fuel processor 3 and fuel cell 4, respectively. There are valves (either solenoid or hand) 46, 44, 43, and 41 installed on pipelines 406, 404, 402, and 400 to control the flow rates of air streams. There are also valves (either solenoid or hand) 11 and 13 installed on pipelines 102 and 106 to control the flow rates of fuel streams. A reformate stream 205 recycled from the exit of the water gas shift reactor R-5 in FIG. 3 is connected to right before the feed compressor entrance to leverage the suction force of compressor 10 to facilitate reformate recycling from a source of higher pressure. A water tank 60 will receive the deionized water 600 from an external deionizer (not shown) and may also receive a water stream 605 that is condensed and collected from fuel processor and fuel cell modules. A coolant tank 70 serves as an expansion tank, in which an electric heater 90 is preferably immersed. The electric heater 90 has two functions, one for heating the coolant during the system start up from cold conditions so that the fuel cell stack can be warmed up to a suitable temperature, and the other for converting the surplus power (i.e. the AC power portion that fuel cell produced cannot be used due to a lower demand) to hot water by heating the coolant that eventually transfers the heat to cogeneration water through a heat exchanger HX-7 in FIG. 4).

FIG. 2b is another embodiment of the balance of plant module 2, in which the air compressor 40 and related pipelines and valves 400, 401 shown in FIG. 2a are removed. In this case, the cathode air supply 401 will be replaced by fuel cell cathode exhaust 507, which initially is supplied from stream 403.

Although not shown, there may have other components inside the balance of plant module 2, but these variations will not alter the principle of the present invention. Also, the connections between the balance of plant module 2 to either fuel processor 3 or fuel cell 4 can be either rigid or flexible, pluggable or unpluggable. It is also understood that the pipelines in FIG. 2a and 2b can be plastic, stainless steel or any other suitable material, in either rigid or flexible form.

The fuel processor used in this invention is preferably steam reforming based, which has been well documented in the art and has been characterized by its high efficiency in hydrogen production compared to other fuel processing process such as autothermal reforming. A steam reformer packed with suitable catalyst, typically Ni—copper-, or noble metal (platinum, palladium, rhodium, and/or iridium) based and readily available from commercial catalysts suppliers, converts a hydrocarbon fuel such as natural gas into a gas stream containing hydrogen, carbon monoxide and carbon dioxide. The steam reforming is a strong exothermic chemical process, and is operated with a steam to carbon ratio of 2 to 4, and preferably between 2.5 to 3 and at temperatures of 650-700° C. The fuel processor used in this invention also includes a medium temperature water-gas shift (MTS) reactor with an operation temperature of preferably 160-300° C. It may also have a low temperature water-gas shift (LTS) reactor operating at temperatures of preferably 160-200° C., the same temperature under which the high temperature fuel cell operates. The fuel processor can further include a steam generator to generate steam quickly to be used in steam reforming. There may also have various heat exchangers inside the fuel processor to bring the various streams to their appropriate temperatures in each step of the process. The fuel processor, in comparison to that commonly used with a low-temperature fuel cell CHP system, has eliminated the PROX reactor, and associated reformate cooler and condenser. The carbon monoxide will be at levels of less than 1%, typically about 0.2-0.6%, in the hydrogen rich reformate before being introduced into the high temperature fuel cells. The elimination of PROX, due to increased tolerance of CO by high temperature fuel cells will significantly increase the simplicity and reliability of fuel processor. It also results in an increase in fuel processor efficiency, which eventually contributes to CHP system efficiency, due to elimination of nitrogen dilution of reformate and hydrogen consumption that would have been caused in PROX reactor. The CHP efficiency is also increased by reducing the parasitic power that would have been consumed by an air blower to supply air to the PROX reactor.

In one of the preferred embodiments schematically illustrated in FIG. 3a, the fuel processing module 3 of FIG. 1 converts the raw hydrocarbon fuel stream 103 into a hydrogen-rich stream 204 for use in high temperature fuel cell module 4 of FIG. 1. The feed stream 103 consisting of natural gas or LPG and recycled hydrogen enters the fuel processing module 3 through a conduit after passing possibly such accessories as compressor 10, solenoid valve 11 and filter (not shown) as illustrated in FIG. 2a and FIG. 2b. The pressurized fuel stream 103, at approximately 2-10 psig and nearly ambient temperature, is directed to a heat exchanger 14 integrated with the MTS reactor R-3 to be preheated to about 200-250° C. that is suitable for the subsequent hydrodesulfurizer R-2. Within the hydrodesulfurizer R-2, a suitable hydrodesulfurization catalyst and an adsorbent (e.g. zinc oxide) or a hydrodesulfurization agent containing both catalyst and adsorbent is packed. In the hydrodesulfurizer R-2, the sulfur components are converted to hydrogen sulfide by reacting with hydrogen in the presence of catalysts, and the hydrogen sulfide is subsequently reacted with zinc oxide to form solid zinc sulfide and steam. The hydrodesulfurizer R-2 is preferably operated at temperatures of 200-300° C., and hydrogen concentration should be maintained in the mixed stream about 0.5-2%. The desulfurized feed stream 109 exiting the hydrodesulfurizer R-2 is then mixed with superheated steam 604. The feed/steam mixture 100 then enters into a heat exchanger HX-4 in which it flows through a heat transfer surface 15 and is preheated up to 400-650° C. by exchanging heat from the heat transfer surface 51 flowing combustion flue gas 500. The preheated feed/steam mixture 111 is directed into steam reformer reactor R-1, which is thermally coupled together with burner R-4 to receive the heat required for endothermic steam reforming reactions (e.g. CH₄+H₂O→3H₂+CO). The steam reformer R-1, with suitable catalyst such as those based on base metal (Ni, Cu/Zn) or precious metal catalysts in tablets, spheres or rings commercially available from Sud-Chemie or Engelhard, operates at approximately 650-700° C., while the combustion chamber is generally 10-50° C. higher. The burner R-4 is specially designed to be operable with mixture of raw hydrocarbon fuel and hydrogen of 0-100%. The reformate 200, still consisting of about 8-10% CO, is directed into a steam boiler HX-3, together with flue gas 501, to provide heat for steam generation and superheating. This steam boiler represents one of the major features of the present invention: it provides sufficiently large amount of heat and heat transfer surfaces (50 and 21) to allow water stream 602 to be quickly evaporated and superheated in a flash-like fashion. Unlike conventional designs in the art in which slow steam generation limits the load following and ramp up capabilities, the flash-like steam generation makes the fuel processor possible to respond quickly to variations in load demand, and to accelerate the ramp up speed. In both the transient processes, the quick steam generation guarantees the fuel processor to operate at any moment without shortage of steam in order to prevent carbon deposition on steam reformer catalysts. The reformate 202 exiting the boiler HX-3 having a temperature of 240-280° C., is sent to a medium temperature shift (MTS) reactor R-3 operating at approximately 250-350° C. to reduce the carbon monoxide to approximately 0.6-1.0% (i.e. CO+H₂O→H₂+CO₂) under a suitable catalyst that is generally CuZn type and can be obtained commercially from Süd-Chemie or Engelhard. As described above, the heat generated by the exothermic shift reaction in the MTS is removed by a heat exchanger 14 to preheat the hydrocarbon fuel 103. Exiting the MTS the reformate 203 is sent to a low temperature shift (LTS) reactor R-5 operating at approximately 160-200° C. to reduce the CO to typically around 0.4-0.6%, which meets the CO level requirement by the high temperature MEA as discussed earlier The heat generated in the LTS is removed by providing a heat exchanger 47 to preheat the combustion air stream 401, or 507 being recycled from fuel cell cathode exhaust. At the exit of R-5 a small amount of the reformate 205 is recycled back to the entrance of the fuel compressor 10. The remaining majority of reformate stream 204 is sent directly to fuel cell system 4 of FIG. 1.

A de-ionized water stream 602 from a storage tank 60 is supplied to steam boiler HX-3 through a speed variable water pump 61 that is controlled to provide a water supply rate corresponding to a desired steam/carbon ration, typically 2 to 4, and preferably 2.5 to 3.0. The water supplied to HX-3 would quickly be evaporated and superheated because of sufficient heat supply from both reformate and flue gas streams 200 and 501. The superheated steam 604 exiting the steam boiler HX-3 is then mixed with the desulfurized feed stream 109 prior to flowing into heat exchanger HX-4. The flue gas stream 501 exiting the heat exchanger HX-4 at about 500-550° C. flows into the steam boiler HX-3 and exits (stream 502) it at about 100-150° C. To maximize the heat recovery, a cogeneration water stream 807 is used to recover the heat from the flue gas stream 502 by heat exchanging in a heat exchanger HX-1. The flue gas 503 exiting the heat exchanger HX-1 will be at a temperature close to ambient, and eventually vented through a chimney (not shown), and the water condensed in the stream may be recovered and recycled back to the water tank 60 (i.e. the stream 605). Although not shown, there are filters on the exits of the steam reformer R-1, MTS R-3, LTS R-5, and HDS R-2 to remove the entrained catalysts from the respective streams.

The anode off gas 300, which is the reformate stream unreacted in the fuel cell stack, is supplied to burner R-4 directly. A small amount of raw hydrocarbon fuel 107 may also be supplied to burner to attain the reformer temperature if the anode off gas is not enough due to higher hydrogen utilization. The burner is designed to be operable with mixture of hydrocarbon fuel and hydrogen of 0-100%.

FIG. 3b shows a schematic for an alternative fuel processor module 3b in accordance with a second embodiment of the present invention. In FIG. 3b, a hydrocarbon feed stream 103 is first directed to a first heat exchanger HX-5 to be preheated up to about 200-250° C. by heat exchanging with a reformate stream 202. The preheated feed stream 108 is then directed into a desulfurizer, preferably a hydrodesulfurizer, R-2 to reduce the concentration of the contained organic and inorganic sulfur compounds to be low enough in order to prevent the downstream steam reforming and shift catalysts from sulfur poisoning. The desulfurized feed stream 109 is first mixed with a superheated steam 604, and then directed into a second heat exchanger HX-4, in which the feed/steam mixture 110 is heated by a hot reformate stream 201 to about 400° C., before being directed into a steam reformer R-1. The steam reformer R-1 is constructed preferably as regeneration type, i.e. thermally incorporated with a third heat exchanger 20 and a combustion burner and chamber R-4. In such a way the heat required by the steam reforming reactions can be directly supplied by hot reformate and combustion. The reformate stream 201 exiting the R-1 is subsequently used preheat the feed/steam mixture 110 in HX-4 and the feed stream 103 in HX-5, before being introduced into a thermally integrated shift reactor R-3 which is operated at a temperature between 160 and 200° C. After R-3 a small amount of the reformate 205 is recycled back to the entrance of the fuel compressor 10. The remaining majority of reformate stream 204 is sent directly to fuel cell system 4 of FIG. 1.

An air stream 401, or fuel cell cathode exhaust stream 507, is first directed to a 5^{th} heat exchanger HX-2 to be preheated up to about 120° C. while cooling down the flue gas stream 501. The preheated air stream 408 is then directed into the burner R-4, in which combustion of fuel stream 107 and anode off gas stream 300 with air takes place. After providing the heat required by steam reforming occurring inside R-1, the flue gas stream 500 is sent to a fourth heat exchanger HX-3, which is thermally integrated with a steam boiler to generate a steam stream 604. The flue gas stream exiting the HX-3 is then subsequently cooled down in HX-2 by incoming cool combustion air 401, and in a sixth heat exchanger HX-1 by a cogeneration stream 807, before being vented out. A de-ionized water stream 602 is first sent to a heat exchanger incorporated with R-3 to be preheated to about 90-100° C., and then directed to the steam boiler HX-3.

By providing the optimized thermal and flow integration, the fuel processor described in the present invention has been performed efficiently and reliably. The produced hydrogen rich gas contains less than 1% of CO, more preferably <0.6% CO, suitable for high temperature fuel cells. The fuel processing efficiency defined by the LHV of produced hydrogen in stream 204 divided by the LHV of total fuel input (streams 103, 107 and 300) can reach about 82-85%.

Based on the process described, all the fuel processing components can be mechanically and thermally integrated into a single containment vessel 3a or 3b to form a compact fuel processor. It is obvious that the mechanically integrated fuel processor has high compactness, smaller size, and higher thermal efficiency. Following the temperature gradient the components are arranged in such a way to optimize the thermal utilization and integration which allows reducing the use of thermal insulation material and heat losses. The outer surface of the fuel processor would be close to room temperature. The distances between adjacent components of different temperatures have been determined by the heat transfer requirements.

In the fuel processor shown in FIG. 3, there are electric heaters 92, 93 and 94, to be used in warm up of HDS R-2, MTS R-3 and LTS R-5 to prevent water condensation over the catalysts during cold startup to potentially damage or reduce the catalyst activity. The water condensation is likely to occur during a cold start-up when the temperature of catalysts is below the dew point of reformate, and therefore the heaters will bring the catalyst temperature above the dew point before the reformate flows through these reactors. If the catalysts work well with water condensation, these heaters can be removed. There may also have an electrical heater 91 attached onto steam boiler HX-3 to assist steam generation, especially during cold start up process.

The fuel processor as disclosed above has several advantages including high efficiency and guaranteed CO concentration in reformate sent to fuel cells. It also features being able to start up from cold conditions. In comparison to a similar fuel processor but with PROX reactor included for supplying hydrogen rich reformate to a low temperature PEM fuel cells, this fuel processor has an increased efficiency, high hydrogen production rate and concentration, no dilution of nitrogen, as listed in Table 1.

TABLE 1
Comparison of reformate composition (dry basis) and fuel processor
efficiency between fuel processors with and without PROX.

| | Fuel Processor | Fuel Processor |
|---|---|---|
| | with PROX | without PROX |
| H₂ | 75.7% | 77.9% |
| CH₄ | 1.48% | 1.54% |
| CO | <10 ppm | 0.47%^{#4} |
| CO₂ | 20.2% | 20.1% |
| N₂ | 2.7%^{#3} | 0% |
| H₂ production rate (H₂ | 4.0 (full load) | 4.2 (full load) |
| moles/mole-natural gas^{#1} | 3.6 (half load) | 3.8 (half load) |
| Fuel Processor | 75.7% | 77.7% |
| Efficiency^{#2} | | |

^{#1}The two fuel processors operate at similar conditions: steam/carbon = 2.5, natural gas composition: CH₄, 88%; C₂H₆: 6%; C₃H₈: 3%, C₄H₁₀: 3%.
^{#2}Fuel processor efficiency is defined as total lower heating value of produced hydrogen divided by the total lower heating value of all hydrocarbon feed and fuel and recycled anode off gas. A reasonable heat loss has been considered in efficiency estimation.
^{#3}Air is supplied to PROX reactor at a rate to attain O/CO = 3.
^{#4}Shift reactor outlet temperature is controlled at 200° C.

FIG. 4a provides one of the preferred embodiments for a fuel cell module 4. The cathode air 403 from a cathode blower or compressor 42 in the balance of plant 2a is sent to a heat exchanger HX-6 to be preheated to a temperature close to the stack temperature by heat exchange with the hot cathode off gas stream 504. The preheated cathode air stream 409 is then sent to the cathode side 53 of the high temperature PEM fuel cell stack FC-1 where the molecules of oxygen containing in the cathode air react with migrated hydrogen protons and electrons from anode side 23 of FC-1 to produce water and heat (O₂+4H⁺+2e⁻→H₂O+Heat). Hydrogen or hydrogen containing reformate stream 204 is supplied directly to the anode side 23 of the fuel cell FC-1 where electrochemical reaction H₂→2H⁺+2e⁻ takes place. The unreacted hydrogen stream, or termed as anode off gas, 300 is then sent to burner R-4 in fuel processor of FIG. 3 to be combusted for supplying heat for steam reforming reactions.

To maintain a constant and uniform stack temperature, the produced heat by fuel cells is removed from the stack FC-1 by flowing a coolant stream 702 through the cooling channel side 73 of the fuel cell stack. The cathode off gas 504, after being used to preheat the incoming cold cathode air 403 in the heat exchanger HX-6, is sent to a heat exchanger HX-8 where it is cooled to near ambient temperature by heat exchange with a cogeneration water stream 808. The exiting cathode air 507 from the heat exchanger HX-8 is eventually vented through a chimney. Again, the water condensate from cathode off gas stream 507 may be collected and returned to water tank 60 in balance of plant module 2.

As described earlier, a cogeneration stream 807 from heat recovery module 5 is first sent to recover the available thermal energy from the combustion flue gas stream 502 in a heat exchanger HX-1, and followed by heat recovery from the cathode off gas in a heat exchanger HX-8. Then, the cogeneration water 809 is sent to a cogeneration heat exchanger HX-7 to recover the thermal energy from coolant stream 704. Exiting the heat exchanger HX-7, the coolant stream 705 flows to an air-cooling heat exchanger HX-9, which is provided, as a backup heat exchanger, to remove the excess heat from coolant 705, and bring the coolant stream 706 to a suitable temperature prior to returning back to coolant tank 70. The air cooling heat exchanger HX-9 will only be in operation when there is no enough, or not thermal demand at all from heat recovery system 5, and therefore in most cases this heat exchanger will stay idle. This heat exchanger can of course be removed if it is advantageous to include it within HRS 5. In operation, the cogeneration water steam 810 is set at about 60 and 65° C. at all times and the coolant stream 705 exiting the cogeneration heat exchanger HX-7 at a temperature that is below the fuel cell stack temperature with a predetermined value, e.g. 3 to 20° C., and more preferably less than 10° C.

FIG. 4b illustrates another preferred embodiment of fuel cell module 4b in accordance with the present invention. Different from the process shown in FIG. 4a, the cathode air stream 403 in this embodiment is first sent to a heat exchanger HX-10 to be preheated by stack coolant stream 704. Due to large heat capacity of the coolant flow, the temperature of coolant streams 704, 707 would remain essentially the same. Exiting the heat exchanger HX-10, the coolant stream 707 is directed to a cogeneration heat exchanger HX-7 in which heat transfer between coolant stream 74 and cogeneration water stream 83 occurs. The cathode off gas from the fuel cell stack FC-1 is directed to another gas-liquid type heat exchanger HX-11 to be cooled by a cogeneration water stream 808, which has been previously preheated slightly by the heat transferred from flue gas exhaust in a heat exchanger HX-1. The advantage of using gas-liquid type heat exchanger rather than gas-gas type heat exchanger as shown in FIG. 4a is to increase the heat transfer performance and thus reduce the heat exchanger size and material cost. Another advantage is that it allows integration of the fuel cell stack FC-1 and heat exchanger HX-10 into a single compact unit. FIGS. 6, 7 and 8 provide three of the preferred embodiments among various possible ways for achieving such integration.

FIG. 6a provides an anode plate 23a, on which a fuel (hydrogen or hydrogen rich reformate) is introduced through a fuel input manifold opening 80, which fluidly connects to a plurality of flow channels on surface B for distributing the fuel to the MEA thereon (not shown). The flow channels, for illustration purpose herein, are shown as a serpentine though other configurations are also employable. The residual fuel exits the active area to the outlet manifold 82.

On the anode plate 23a, there is a secondary zone formed by a plurality of flow channels on surface A, which fluidly connects from a cathode air input manifold opening 83 and to a transportation manifold opening 83a.

FIG. 6b provides a cathode plate 53a, on which again two separated zones B′ and A′ are formed. The first zone formed by a plurality of flow channels facing the flow channels on surface B on anode plate 23a separated by high temperature MEA and, if necessary, gas diffusion layers between. The cathode air, which has been preheated when flowing through flow channels surfaces A on anode plate 23a and A′ on cathode plate 53a, is directed to flow channels on surface B′ from transport manifold 83a and exits the active area to an outlet manifold opening 85.

FIG. 6c provides a cooling plate 73, which, in most cases, is the back surface of the cathode plate 53a. A suitable coolant, such as water and some heat transfer fluids, is introduced into a plurality of flow channels on surface C through an inlet manifold opening 86 and exits to an outlet manifold opening 87. Unlike anode plate 23a and cathode plate 53a, there is only one zone on the coolant plate 73a, which covers the two zones formed by areas A and B on anode plate 23a and A′ and B′ on cathode plate 53a.

The preheating of cathode air is achieved by flowing cathode air and coolant over the heat transfer zone corresponding to the area A and A′. As incoming cathode air passes through the heat transfer zone A and A′, it receives the heat transferred from coolant that is substantially close to the stack temperature on the other side of the plate. Due to large heat capacity of coolant, temperature change of coolant due to heat transfer for preheating cathode air is negligible and thus will not change the plate temperature uniformity noticeably.

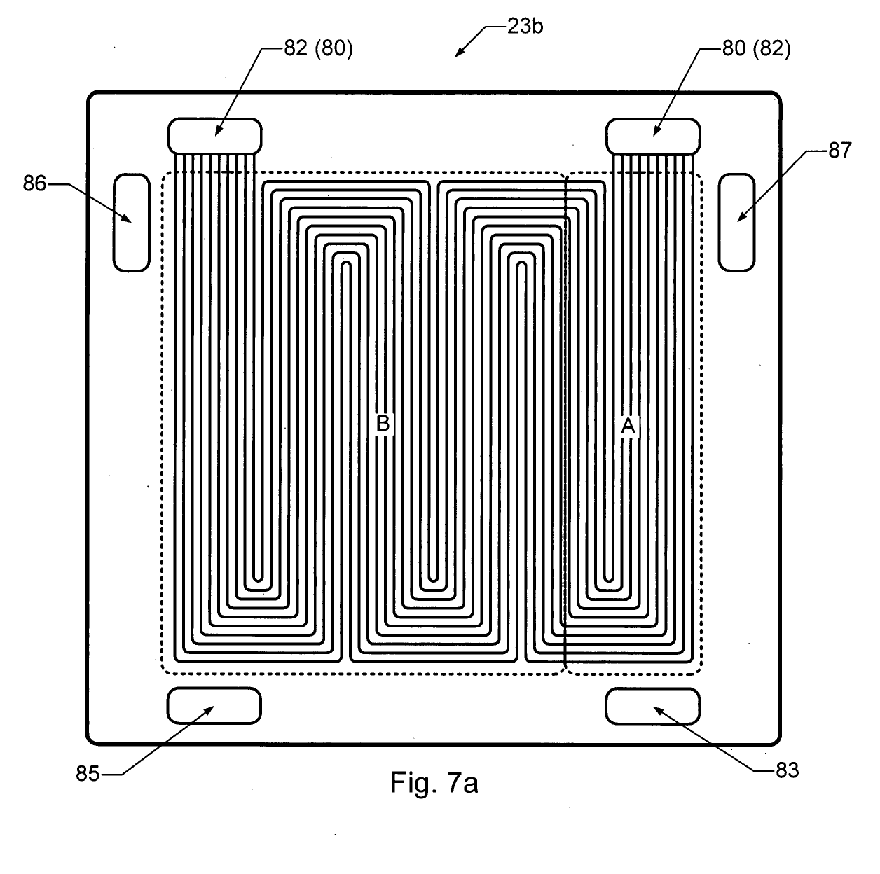

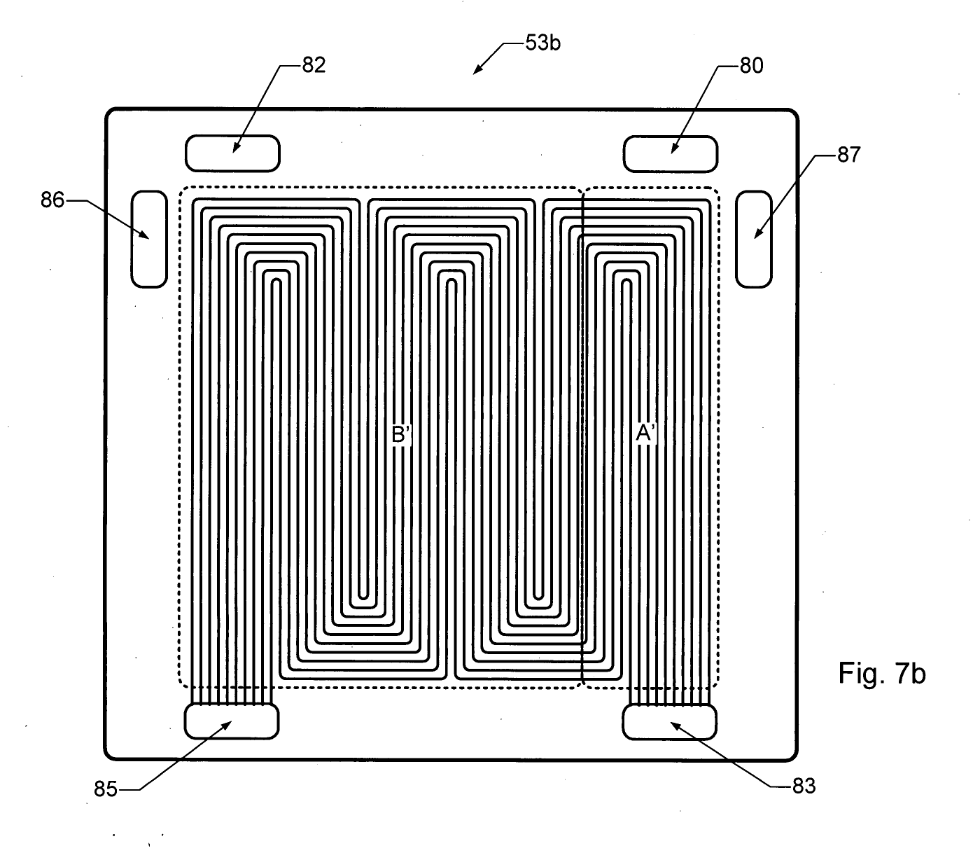

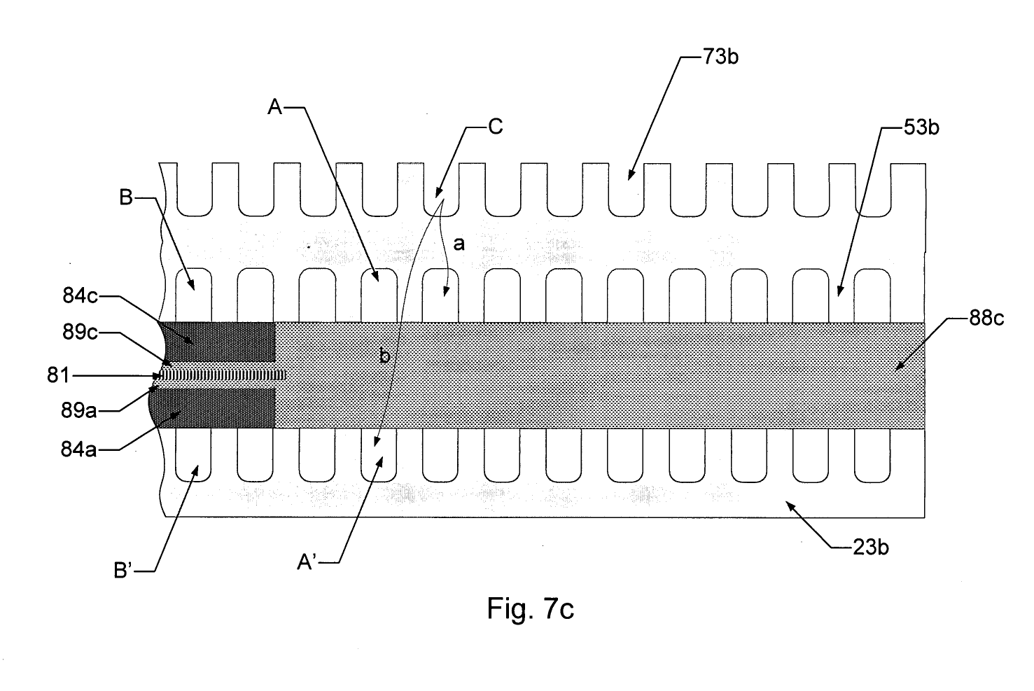

There is provided a second anode plate 23b in FIG. 7a and a second cathode plate 53b in FIG. 7b in accordance with the present invention. For convenience, all numerical reference numbers have been designed to be the same as in FIG. 6, and therefore only differences will be discussed. Unlike in FIG. 6 where the preheating zone is separated from the active zone and only cathode air is preheated, the preheating zone A in FIG. 7 is fluidly connected to the active area B without separation for preheating incoming hydrogen or reformate which might have a temperature lower than the stack temperature. In FIG. 7b, there is a cathode air preheating zone A′ facing anode preheating zone A in FIG. 7a and an active area B′ facing the active area B in FIG. 7a. Again, the zone A′ and zone B′ are not separated.

FIG. 7c illustrates a preferred MEA structure to be used between anode plate 23b and cathode plate 53b according to one of the embodiments of the present invention. In the zone A and A′ incoming cathode air and incoming fuel flow inside the flow channels which might mate each other but be separated by a gasket layer 88c. On the back surface of the cathode plate 53b, there are coolant flow channels C in which coolant flows with a temperature close to the cell temperature. Since the plate is made of both electrically and thermally conductive material, heat can be transferred from hot coolant to incoming cathode air (e.g. along path a) and even to incoming fuel (e.g. along path b). The gasket layer 88c may also be alternatively made of a membrane 81 disposed between two gas diffusion layers 84a and 84c. Differing from the MEA corresponding to the active area B, B′, there would be no catalyst layers in the area 88c.

Corresponding to the active area B and B′ in FIG. 7c, there is a MEA (membrane 81, anode catalyst layer 89a, cathode catalyst layer 89c, anode gas diffusion layer 84a and cathode gas diffusion layer 84c) sandwiched between flow channels in area B and B′. The MEA and 88c can be bonded together in any appropriate mechanism.

Alternatively, the fuel stream can be arranged to enter the anode flow field from manifold 82 and flows into area B in countercurrent to cathode air which enters from inlet manifold 83 and flows first into area A. In this case, the anode residual gas will exit from area A to outlet manifold 80. Over the area A there will be anode residual gas which has a temperature approximately same as stack temperature on one side of the separation layer 88c and incoming cold cathode air on other side of the separation layer 88c. In addition to heat transferred from hot coolant flowing on back side of the cathode plate, the air may be also heated up by heat that may be transferred from hot anode stream flowing on the other side of the separation layer 88c.

It should be understood that the shape of plates, shapes and positions of fluid manifolds, configurations of flow channels as well as relative positions and arrangements of heat transfer zone and fuel cell electrochemical reaction zone are displayed in FIGS. 6 and 7 for illustration purpose only, and therefore they can take any desirable shapes, arrangements, patterns, configurations without departing from the principles of the present invention. For instance, there may be a first manifold (not shown) fluidly connecting to a secondary manifold 80, 83 or 86 to achieve uniform gas and coolant distribution into each individual cell in a fuel cell stack comprising a plurality of cells. The details of this unique manifold design have been disclosed in co-pending U.S. patent application Ser. No. 01/861416, which is hereby incorporated by reference. Furthermore, the number of flow channels can be variable, and is the largest for the first path and then reduces stepwise towards downstream with a reduction rate in the number of flow channels determined in accordance with the reactant gas consumption rate due to progressive electrochemical reaction. The details of this unique flow field design have been disclosed in co-pending U.S. patent application Ser. No. 01/861409, which is also hereby incorporated by reference.

Now, back to FIG. 4a and FIG. 4b, the cathode off gas stream 410 can be either directly vented through a chimney (not shown), or sent to fuel processor 3 to replace combustion air 401. In the former case the balance of plant module 2a will be used, while the balance of plant module 2b will be used in the latter case.

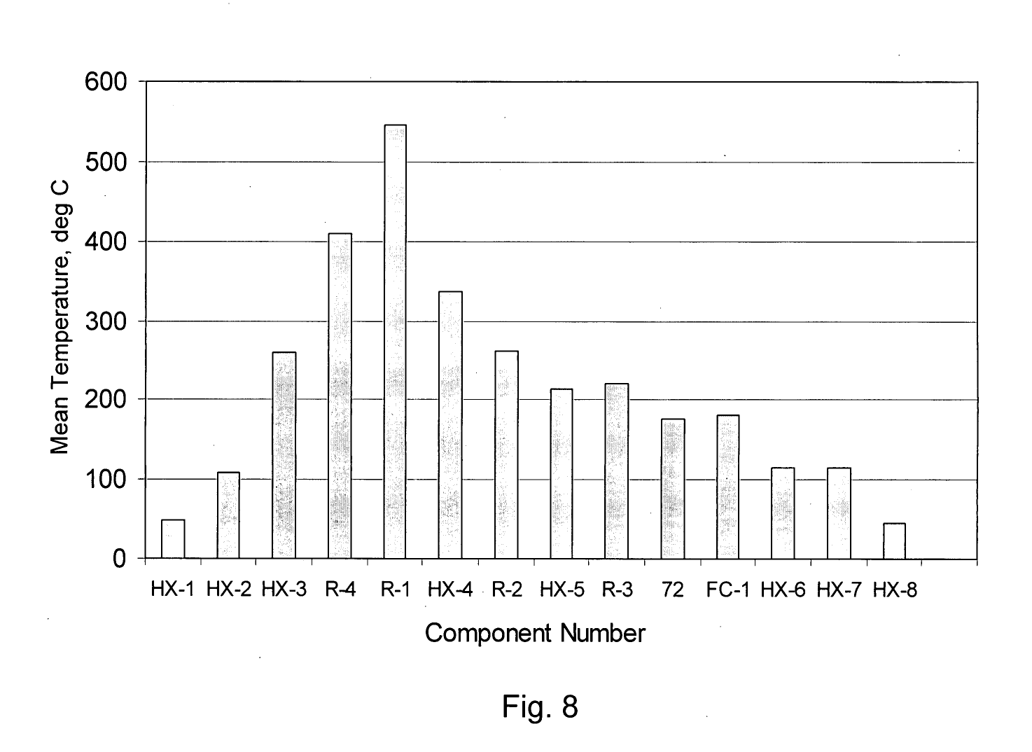

It is appreciated from FIGS. 3 and 4 that the fuel processor and fuel cell module components have been arranged in such a manner that maximum thermal efficiency can be achieved. As shown in FIG. 8, the components of low temperature are arranged in the outer side of the package and the components of high temperature are located in the center. Generally, a component having a higher temperature that would lose heat is arranged to be beside a component having lower temperature that would receive this heat for heating purpose. Such an arrangement would also maximize the system efficiency by reducing the heat loss to environment because the temperature difference between the outer surface of the package and environment would be minimized, which in turn requires thinner insulation material and thus reduces the system material cost.

It is also appreciated that the fuel processor module 3 and fuel cell module 4 can be mechanically installed separately, but preferably combined to form a single compact package by installing fuel cell module 4 right next to fuel processor module 3. To maintain a proper temperature profile within the combined fuel processor and fuel cell package, 3 and 4, a suitable thermal insulation material such as those commercially available from Microtherm® would be employed between adjacent components with an appropriate thickness. Then, the entire package of combined fuel processor and fuel cell, 3 and 4, would be insulated by an external insulation shell with a thickness of about 0.5 to 1 inches so that the external surface of the package would have a temperature close to ambient (i.e. 20-25° C.).

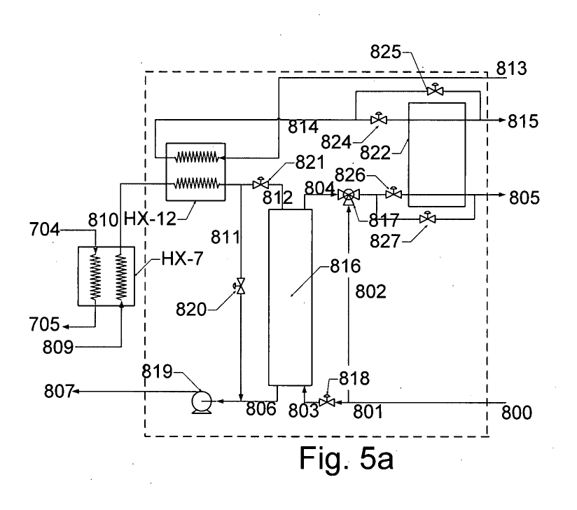

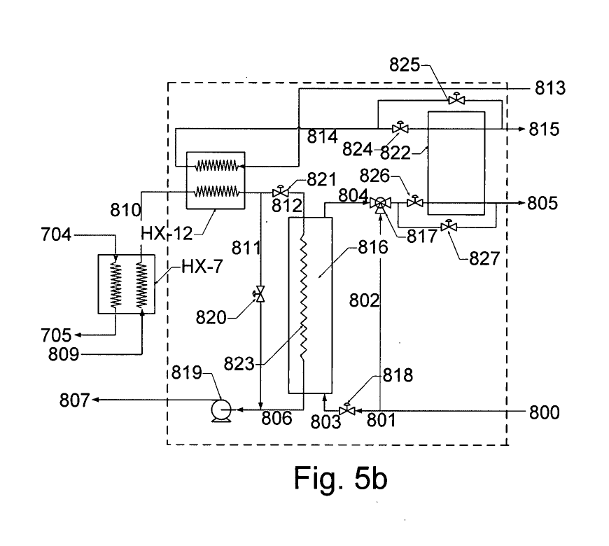

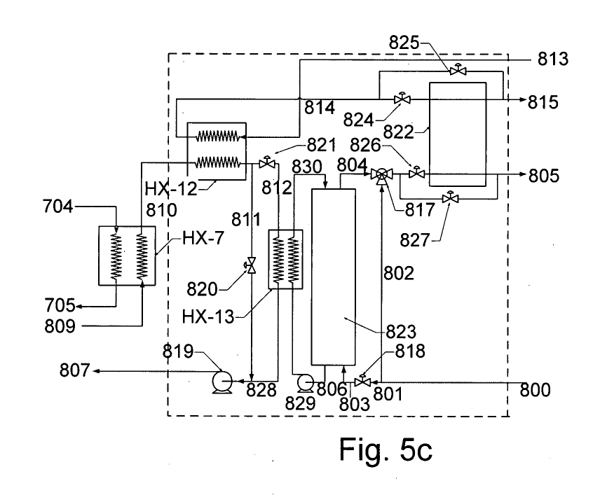

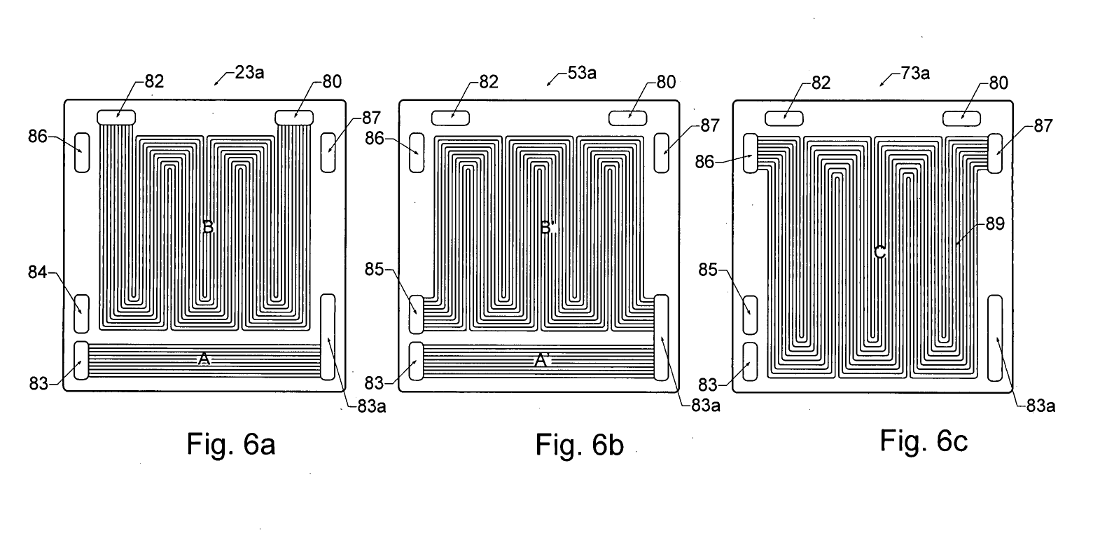

Now reference will be made to FIG. 5a for an alternative embodiment of heat recovery module 5 according to the present invention. There is provided a heat recovery module 5a, in which a thermal storage tank 816 is installed to temporally store the recovered thermal energy from fuel processor 3 and fuel cell 4 as discussed earlier. Interfaced with a cogeneration heat exchanger HX-7 of fuel cell module 4, the produced hot water 810 is first directed into a heat exchanger HX-12, in which part or all of the available thermal energy of hot stream 810 will be transferred to a cold water stream 813, 814 to produce a hot water stream 815 to be used for space heating and/or driving an absorption heat pump for air-conditioning application, which is practically feasible because the CHP systems according to the present invention have higher thermal energy output (see Table 2 below for reference). As a result, the CHP system efficiency and applicability would be further increased according to the present invention. This feature is particularly important for CHP systems to operate more efficiently during summer seasons when there is a lower domestic hot water and heating demand, but a higher air-conditioning demand.

When there is a full demand from space heating and/or air-conditioning, the temperature of hot water stream 810, after exiting the heat exchanger HX-12, could be too low to be fed into the water storage tank 816, and therefore be circulated through a pipeline 811 to the entrance of the water circulation pump 819. In this case, valve 820 will be open and valve 821 will be closed.

In case there is still available thermal energy in hot water stream 810 after the heat exchanger HX-12, which would occur if there is completely no, or no enough thermal demand from space heating and/or air conditioning, the valve 820 may be partly open, and the valve 821 may be partly open or closed depending on the temperature of water stream after the heat exchanger HX-12. Opening the valve 821 will flow the hot water stream 812 into the thermal storage tank 816 for thermal energy storage. In this case cold water 806 will be withdrawn from the bottom of the tank 816 and be circulated by water pump 819 back as stream 807 back to HX-1 of fuel processor in FIG. 3.

There is also provided a backup gas burner (gas and air supply lines are not shown) 822 inside the heat recovery module 5a. The backup burner provides the thermal energy shortage of the CHP system. The backup burner operates, if necessary, to supply the hot water stream 815 for space heating and/or air conditioning and domestic hot water stream 805 at their preferred temperatures. City water 800 is supplied to the heat recovery module 5a, part of it 802 may be mixed with hot water stream 804 from the top of tank 81 to provide a domestic hot water stream 805, and rest of it 803 may be supplied to the bottom of tank 816.

Depending on the operation conditions, water stream 814 might be bypassed the supplementary burner 822 by simultaneously opening valve 825 and closing valve 824. This could happen when the stream 814 is hot enough and stream 804 is cold and the burner 822 needs to operate in order to bring the hot water stream 805 to an appropriate temperature. Similarly, the water stream 804 may be bypassed the supplementary burner 822 by simultaneously opening valve 827 and closing valve 826. This could happen when the stream 804 is hot enough and stream 814 is cold and the burner 822 needs to operate in order to bring the hot water stream 815 to an appropriate temperature.

The hot water is fed into the top of a thermal storage tank 816, in which a temperature gradient is kept so that water temperature declines from top to bottom, and therefore cogeneration water that is sent to fuel processor module 3 and fuel cell module 4 always has a lower temperature in order to maximize the heat recovery efficiency. The circulation of cogeneration water is driven by a pump 819, which is preferably a speed variable pump and will be controlled by the control system in order to ensure the returning cogeneration water with a temperature between 60 and 65° C. at all times and the coolant stream 705 exiting the cogeneration heat exchanger HX-7 at a temperature that is below the fuel cell stack temperature with a predetermined value, e.g. 3 to 20° C. A mixing valve 817 may be installed to provide the hot water stream 805 at a preferred temperature, e.g. 43-50° C. by mixing a hot water stream 804 drawn from the top of the water tank 816 and a cold city water stream 802. At moments when the water stream 805 cannot reach this preferred temperature, the backup gas burner 822 will operate to heat up the water to meet the demand.

The preferred embodiment shown in FIG. 5a allows the use of water as cogeneration fluid. However, in some other cases water cannot be used as the cogeneration fluid. In these cases, a heat recovery module can be designed as shown in FIG. 5b. In this preferred embodiment, instead of circulating cogeneration water from tank 816 directly, a heat exchanger 823 is immersed inside the water tank 816. Heat carried by the cogeneration fluid 812 is released to water inside the tank 816 through heat exchanger surface 823 which in intimate contact with water.

Other variations to FIG. 5b are also possible. For instance, an external heat exchanger HX-13 may be installed to facilitate heat transfer between cogeneration water streams 812, 828 and domestic water stream 806, 830, which may be circulated between HX-13 and hot water storage tank 816 by a water pump 829, as schematically shown in FIG. 5c. In both cases of FIGS. 5b and 5c, the cogeneration fluid can be possibly water or other heat transfer liquids depending on the practical design and operation considerations.

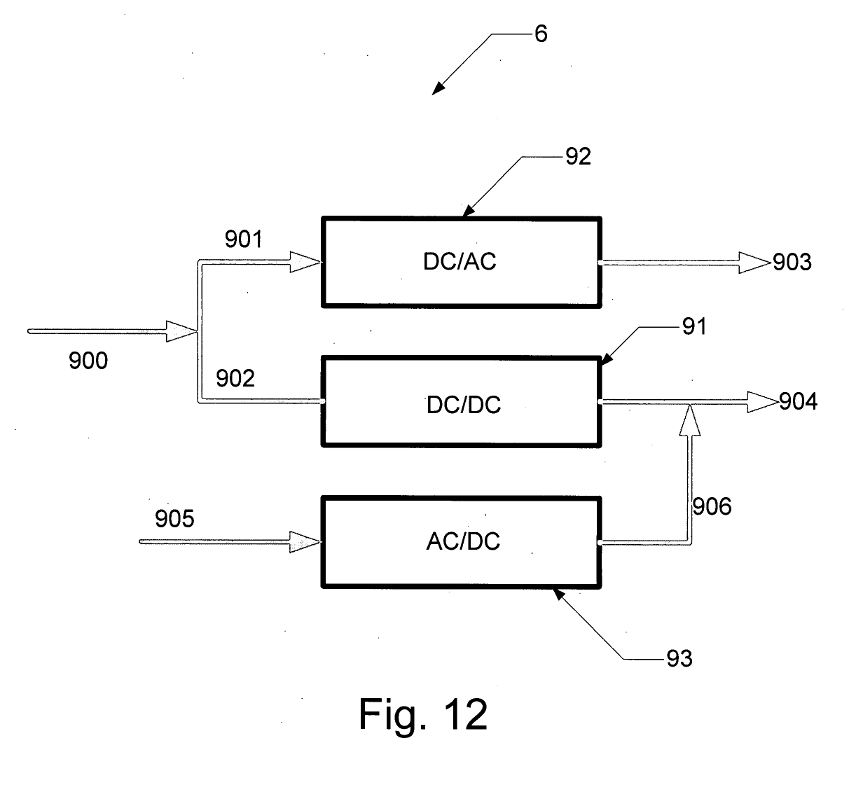

Reference will be now made to FIG. 12, in which a generic power conditioning module 6 is illustrated according to the present invention. The power conditioning module 6 comprises a first inverter 91 which converts part of fuel cell generated unregulated DC power 902 into a regulated DC power 904 with a preferably voltage such as 12 V or 24 V. The converted DC power of 12 V or 24 V will be supplied to electrical and control a module 7 to power and control all system electronic components including data acquisition system, control boards (analog or digital), pumps, blowers/compressors, solenoid valves, and so on. A second inverter 92 converts the majority of fuel cell generated unregulated DC power 901 to regulated AC power 903 with a preferable voltage such as 110/120 V, 100/200 V or 220/240 V and a preferred frequency such as 50/60 Hz. This regulated AC power will be supplied to meet the actual electrical load demand. There is also a third inverter 93 that converts regulated AC electricity 905 from an existing grid to a regulated DC power 906, which is the same DC power as 904 and only be used during CHP system startup process when the electrical power from fuel cells is not available.

During a cold start up process, three electric heaters 92, 93, and 94 will operate with electricity from grid to warm up the hydrodesulfurizer R-2 and water gas shift reactors R-3 and R-4. If necessary, electrical heater 91 may also be powered on to accelerate steam generation. The electric heater 90 immersed inside the coolant expansion tank 70 may also be used to heat up the coolant that will be circulated to bring the fuel cell stack to a first preferred temperature of about 55-60° C. At the meantime, hydrocarbon fuel 107 and combustion air 401 will be supplied to burner R-4 to start combustion for preheating reformer R-1. Depending on the characteristics of the individual devices, the start time of these electrical heaters may be different. On the other hand, the power outputs of these electrical heaters may also be designed differently to optimize the warm up processes.

As soon as the temperatures of hydrodesulfurizer R-2, water gas shift reactor R-3 and R-4, and reformer R-1 have achieved their individual predetermined values, and the fuel cell stack FC-1 has also reached its first preferred temperature of 55-60° C., hydrocarbon feed 103 is supplied at a predetermined rate, probably 10-30% of full capacity, under which a self-sustainable operation would be attained. Under self-sustainable operation, hydrocarbon fuel stream 107 would be cut off, and the fuel cell stack FC-1 would remain idle (no current is drawn). The produced synthesis gas 204 will be completely recycled to burner R-4, and its combustion heat is just appropriate to maintain a stable operation and temperature profiles for the system components. Operation of the system under self-sustainable conditions will further preheat the system while allowing electric heaters to be cut off.

Since the fuel cell stack FC-1 is already preheated to its first preferred temperature before starting self-sustainable operation, there will be no worry of water condensation inside the fuel cell stack when water-containing reformate flows through the stack. Water condensation over PBI type high temperature MEA could result in acid washout to degrade the MEA performance and shorten its lifetime. Operation of the system under self-sustainable conditions will bring the fuel cell stack FC-1 to a second preferred temperature, typically about 120° C., above which current can be safely drawn from stack without damaging to the high temperature MEA.

When fuel cell stack FC-1 reaches this second preferred temperature, a suitable and lower than normal operational current will be withdrawn from the stack, and fuel cell stack will be heated up itself by the heat it produced. No cogeneration would occur during this stage. This fuel cell stack self-preheating process continues till the stack temperature reaches operation temperature of between 160 and 200° C.

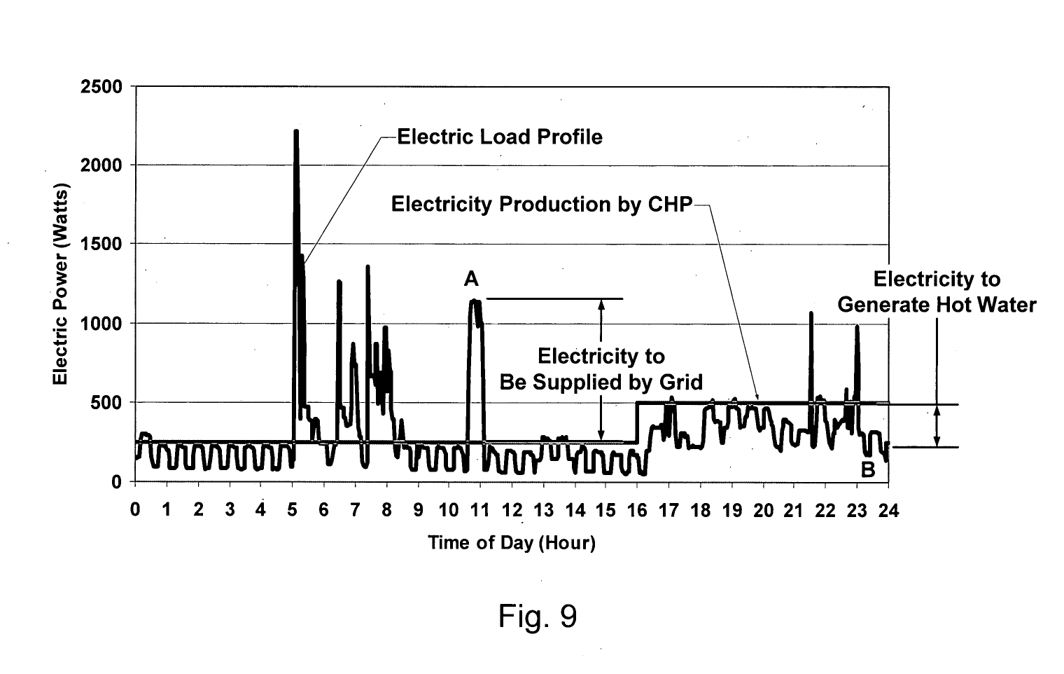

When the system reaches the conditions under which a normal operation can be established, all fluid streams including feed, fuel, combustion air, cathode air, coolant and cogeneration water will flow in a controlled manner to meet the system operation requirements. The CHP system is preferably operated at a simple load-following mode (i.e. 2 to 3 cycles a day), with the switches between different loads being primarily determined by matching the thermal energies between the CHP system daily production and the sum of house daily consumption and losses. FIG. 9 illustrates a typical CHP load-following operation. In the example shown in FIG. 9, the CHP system operates at 50% of load from midnight to 4:00 PM and 100% of load for the rest of day. The time at which the CHP switches from one load to another depends the thermal and electrical load profiles and the CHP performance. According to the present invention, the control module of the CHP system would have a functional mechanism to determine the load following operation, by reference to the previous day's thermal energy consumption and making necessary adjustments.

During normal operation, the control module 7 and power conditioning module 6 would monitor the actual power load and compare it with the fuel cell power output 903. As exemplary illustrated in FIG. 9, at moments when the actual electric power demand is higher than the electricity production by CHP, such as at point A, the electricity shortage will be supplied by an existing grid. At moments when the electricity production by CHP exceeds the actual electric power demand, such as at point B, the surplus power will be supplied to the electric heater 90 (FIG. 2) to heat up coolant, which eventually transfers the heat to heat recovery module 5.

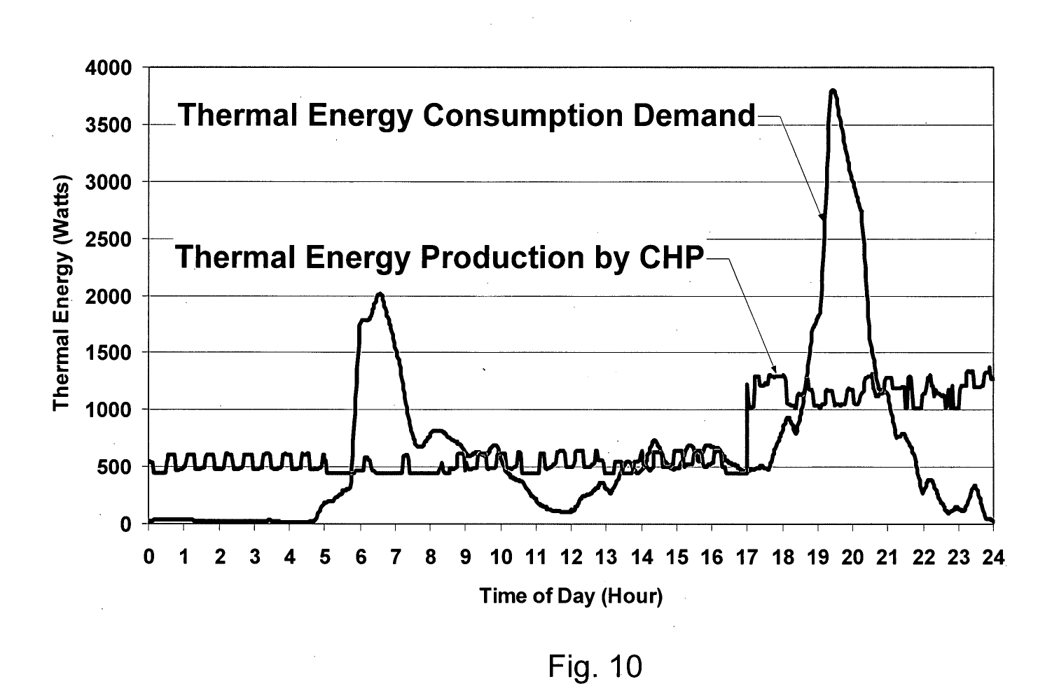

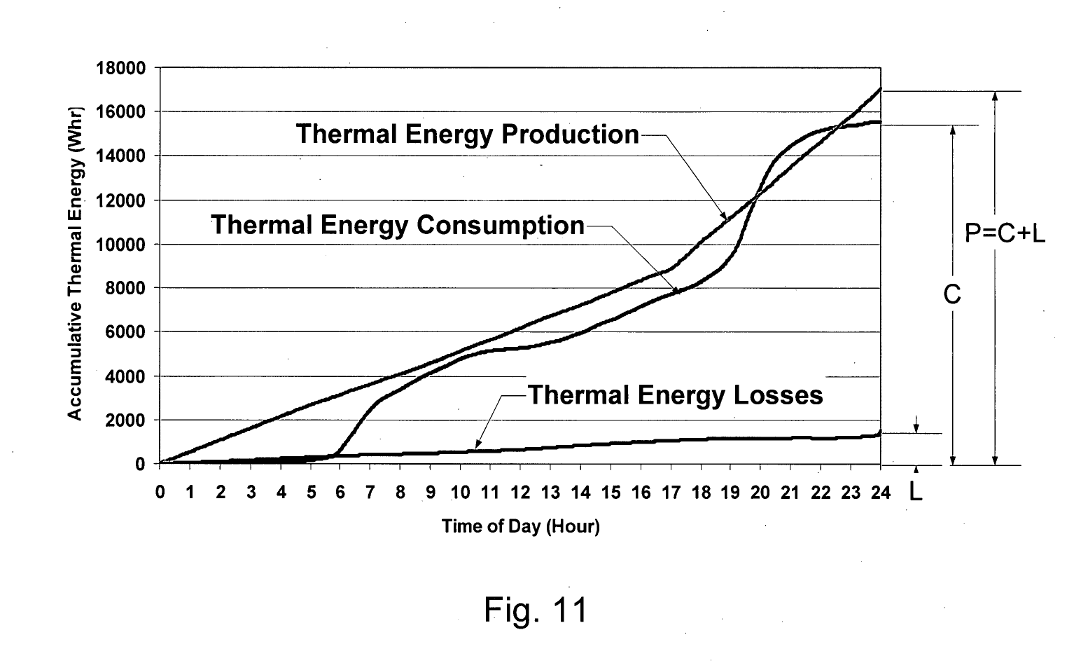

FIG. 10 provides exemplary profiles of thermal energy consumption and thermal energy production by CHP for a typical day from a typical house. At moments when the actual thermal energy demand is lower than the thermal energy production of CHP, such as between 0:00 to 5:00, the thermal energy produced will be simply stored in a thermal storage tank 816 of FIG. 5 during which the front of the hot water would move downward inside the tank. At moments when the actual thermal energy demand is higher than the thermal energy production of CHP, such as between 6:00 to 9:00 and 19:00 to 21:00, the produced thermal energy, plus the stored thermal energy, will be supplied to meet the demand. With appropriate control of the CHP system, at the end of a day the accumulative thermal energy production would equal the sum of the accumulative thermal energy consumption and the accumulative energy loss, as exemplarily shown in FIG. 11, in which P represents the accumulative thermal energy production, C the accumulative thermal energy consumption and L the accumulative thermal energy loss to environment. It shows that by operating the CHP system properly, the accumulative thermal energy production will well meet the thermal energy consumption plus the loss at the end of day (P=C+L), although it might be different during the day.

When there is a need to shut down the CHP system, the operation process will preferably follow the steps: (1): cut-off the current collection from fuel cell stack FC-1; (2): stop supply hydrocarbon feed 103 to fuel processor 3; (3): stop supply water 602 to steam generator HX-3 after a predetermined time period after the hydrocarbon feed is stopped. A time delay is preferred to ensure fully conversion of hydrocarbon over fuel processing catalysts and thus removal the risk of carbon decomposition to cause catalyst deactivation; (4) : open the valve 44 within the balance of plant module 2 to bring a small amount of air 405 to anode side 23 of fuel cell stack FC-1, while keeping supply air 403 to cathode side 53 of the fuel cell stack FC-1. This process will purge the stack and remove all residual water from the stack while stack temperature is still high to ensure no water condensation occurs during shut down, and no water remains within the stack after shut down. Bringing a small amount air to anode might also help the anode catalysts recovery from CO that has adsorbed on catalysts during operation; (5): After the fuel cell stack and fuel processor is fully purged, cut off hydrocarbon fuel 107 to burner, and keep cogeneration water and stack coolant in operation for a predetermined time; (6) when the stack temperature reaches a predetermined temperature below which no thermal energy could be effectively recovered, all the system can be shut down.

It should be appreciated that a CHP system as disclosed in this invention has several significant advantages, especially compared to systems of low temperature PEM system. The major advantage would be significantly improved system reliability and robustness because elimination of technical barriers in relation to water management, humidification and carbon monoxide poisoning. Other advantages include: increased system efficiency, increased system mechanic compactness, and reduced costs in relation to heat exchangers. Table 2 provides a comparison of performance of low temperature PEM and high temperature PEM based CHP systems.

TABLE 2

| | HT-PEM CHP | | LT-PEM CHP | |
|---|---|---|---|---|
| | Systems^{#1} | | Systems^{#2} | |
| Operation Capacity | 100% | 50% | 100% | 50% |
| Heat to electric ratio | 2.0 | 1.6 | 1.2 | 1.0 |
| Fuel to electricity efficiency | 30% | 29% | 35% | 31% |
| Cogeneration efficiency | 61% | 47% | 42% | 33% |
| System efficiency | 91% | 76% | 77% | 64% |

^{#1}CHP system is configured as FIG. 1 of the present invention, and high temperature MEA of PEMEAS is employed.
^{#2}CHP system is similar to FIG. 1 but with a PROX reactor added into fuel processor 2. Low temperature MEA of W. L. Gore and Associates is used.

It should be understood that the forgoing description is intended to illustrate and not limit the scope of the invention, which is defined by the appended claims.

We claim:

1. A method of initiating operation of a fuel cell system having a fuel processor for generating hydrogen from a hydrocarbon fuel, and a high temperature hydrogen fuel cell, the method comprising:
preheating the fuel processor to perform without risk of catalyst damage and deactivation due to reasons including water condensation and CO poisoning using electric heaters and a gas burner;
preheating a fuel cell stack of said fuel cell to a first preferred temperature by electric heaters, above which water in reformate will not be condensed over high temperature membrane electrode assemblies (MEA) of said fuel cell stack to cause acid washout;
operating said fuel processor to begin hydrogen generation while feeding hydrogen back into said gas burner as required;
feeding hydrogen gas from said fuel processor at a second preferred temperature to preheat said fuel cell stack while drawing no substantial current from said fuel cell stack by operating said fuel processor under self-sustainable conditions, said second temperature being a temperature above which current can be safely drawn without damaging said high temperature MEA;
preheating said fuel cell stack to its operation temperature by stack self-preheating; and
subjecting said fuel cell to normal operation after reaching said operation temperature.

2. The method as claimed in claim 1, wherein said fuel cell system is a combined heat and power (CHP) or cogeneration system and further comprises a heat recovery system to provide thermal output from one or both of the fuel processor and the fuel cell system, the method further comprising providing said thermal output.

3. The method as claimed in claim 1, wherein said first preferred temperature is above 55° C.

4. The method as claimed in claim 1, wherein said second preferred temperature is above 120° C.

5. The method as claimed in claim 1, wherein said operation temperature is between 160 and 200° C.

6. The method as claimed in claim 1, wherein said hydrogen gas fed through said fuel cell during preheat to said second preferred temperature is returned to said burner for combustion.

7. The method as claimed in claim 1, wherein:
said burner normally consumes a variable mixture of hydrocarbon fuel fed to said fuel processor and available hydrogen gas produced by said fuel processor and unconsumed by said fuel cell stack to meet the heating needs of said fuel processor;
during initial operation, the hydrocarbon fuel is directed to said burner entirely until said fuel cell stack reaches a third temperature above said first temperature;
when said third temperature is reached, hydrogen gas produced from said fuel processor is fed to said fuel cell stack up to a maximum desired flow rate for preheating said fuel cell stack to said first temperature with essentially all of said hydrogen gas being unconsumed by said fuel cell stack being fed to said burner;
during normal operation, hydrogen gas is controlled to be fed entirely to said fuel cell stack with any hydrogen gas unconsumed by said fuel cell stack being fed to said burner.

8. The method as claimed in claim 1, wherein said feeding hydrogen gas from said fuel processor at a second preferred temperature to preheat said fuel cell stack comprises said fuel processor operating at between 15% and 35% of normal capacity.

9. The method as claimed in claim 1, wherein cogeneration of heat from said fuel cell system only begins after said preheating of said fuel cell stack to its operation temperature.

10. The method as claimed in claim 1, wherein quick steam generation is accomplished by supplying two heating sources.

11. The method as claimed in claim 1, further comprising operating the gas burner in the fuel processor to accelerate fuel processor warm up and steam generation.

12. The method as claimed in claim 1, wherein incoming cathode air is preheated to close to stack temperature

13. The method as claimed in claim 12, wherein said incoming cathode air is preheated by cathode exhaust.

14. The method as claimed in claim 12, wherein said incoming cathode air is preheated by coolant in a heat exchanger.

15. The method as claimed in claim 12, wherein said incoming cathode air is preheated in-cell by coolant and transported by a transportation manifold in said fuel cell stack.

16. The method as claimed in claim 12, wherein said incoming cathode air is preheated by anode residual gas.

17. The method as claimed in claim 1, wherein said fuel processor and fuel cell are mechanically integrated by providing components of high temperature centrally and components of low temperature on a periphery of a package.

18. A combined heat and power, or cogeneration, system combining a fuel cell for generating electrical power with a thermal power source, the system comprising:
a fuel processor for converting a hydrocarbon fuel into hydrogen in an output stream, the hydrogen rich output stream containing a low content of carbon monoxide;
a high temperature hydrogen fuel cell system tolerant to carbon monoxide of up to 5% receiving said output stream and an oxidant fluid stream; and
a heat exchange system having a first module associated with said fuel processor and a second module associated with said fuel cell system connected at least in part in series to provide a thermal output.

19. The combined system as claimed in claim 18, wherein:
at least one of said fuel processor and said fuel cell system comprise a dual purpose electric heater for warming up a component of the combined system;
said heat exchange system comprises a heat exchanger able to extract heat from said component and adapted to receive heat from said dual purpose electric heater;
the combined system further comprising:
a control circuit for directing surplus electrical power from said fuel cell system to said dual purpose electric heater to convert said surplus electrical power into additional thermal output of said heat exchange system.

20. The combined system as claimed in claim 19, wherein said heat exchange system provides hot water.

21. The combined system as claimed in claim 18, wherein said fuel cell system comprises a fuel cell stack having a plurality of plates compressed together and having inlet and outlet manifolds for distributing incoming and outgoing fluids and air into said stack.

22. The combined system as claimed in claim 21, wherein said fuel cell stack comprises at least one anode plate having an active zone for a fuel to be distributed to a membrane electrode assembly and a preheating zone for preheating cathode air, said active zone and said preheating zone being separate from each other.

23. The combined system as claimed in claim 21, wherein said fuel cell stack comprises at least one anode plate having an active zone for a fuel to be distributed to a membrane electrode assembly and a preheating zone for preheating cathode air, said active zone and said preheating zone in fluid communication with each other.
